(19) United States
(12) Patent Application Publication
(10) Pub. No.: US 2005/0248777 A1
(43) Pub. Date: Nov. 10, 2005

(54) System to scan image for wallpaper display and method thereof

(76) Inventor: Yang-moon Kim, Yongin-si (KR)

Correspondence Address: STANZIONE & KIM, LLP, 919 18TH STREET, N.W., SUITE 440, WASHINGTON, DC, 20006, US

(21) Appl. No.: 11/109,700

(22) Filed: Apr. 20, 2005

(30) Foreign Application Priority Data
Apr. 26, 2004 (KR) 2004-28684

(51) Int. Cl. G06K 15/00; G09G 5/00; H04N 1/04; H04N 1/393; G06F 17/00; G06T 3/40

(52) U.S. Cl. 358/1.2; 358/442; 358/474; 345/667; 358/451; 345/698; 345/699

(57) ABSTRACT

A system to set a scan image as wallpaper includes a scanner and a host. The scanner includes a scanning part to scan a document and to form image data, an interface to communicate with another medium, and a control part to control the scanning part and the interface to transfer the image data to another medium via the interface. The host is connected with the scanner, and includes a driver program unit to drive the scanner, an application program unit to generate an image file by processing the image data transferred from the scanner, and a monitor to display the image file. When an automatic wallpaper setting is selected, the host processes the image data formed by the scanner according to a scan command to generate an image file, and automatically sets the image file as wallpaper on the monitor. Accordingly, user inconvenience in the process of scanning and setting wallpaper can be prevented, and wallpaper of image quality and size corresponding to a screen size and resolution of the monitor can be provided.

### CROSS-REFERENCE TO RELATED APPLICATIONS

This application claims the benefit under 35 U.S.C. § 119 of Korean Patent Application No. 2004-28684, filed Apr. 26, 2004, in the Korean Intellectual Property Office, the disclosure of which is incorporated herein in its entirety by reference.

### BACKGROUND OF THE INVENTION

1. Field of the Invention

The present general inventive concept relates to a system to scan and set a scan image as wallpaper on a display, and a method thereof, and more particularly, to a system capable of automatically adjusting a resolution of a scan image to suit the requirements of a display, such as size and resolution, scanning an image according to the adjusted resolution, and setting the scan image as wallpaper of the display.

2. Description of the Related Art

An image apparatus, such as a scanner or a multiplex machine including a scanning function, generally scans a document and converts the scanned result into image data of predetermined image formats, such as JPEG and TIFF formats, and then transfers the converted image data to a host, such as a computer. The computer is generally installed with a driver program for driving a scanner, together with application programs for driving the driver program and processing the image data generated at the scanner.

FIG. 1 is a flowchart illustrating a conventional method for setting a scanned image as a wallpaper of a display.

In order to set the scanned image as a wallpaper on a display, a user first operates the application program of the computer (step S10), and loads the driver program (step S20). The user sequentially sets scanning options, such as chromatic/monochromatic scanning, resolution and area for scanning (step S30), and presses a scanner driving button to activate the driver program and to drive the scanner to perform the scanning operation (step S40). The scanned image data is transferred to the computer, where the data is processed by the application programs.

Meanwhile, in order to set the scanning image data to suit the screen size of the computer display, the user checks the resolution of the screen, and reduces or enlarges the scanned image data by use of professional image processing programs (step S50), and stores the processed image data in the form of a file (step S60).

The user then loads a UI (user interface) of registration information of the computer display (step S70), designates on the wallpaper setting screen the scanned image data to be used as the wallpaper (step S80), and presses a button for conversion of loaded image data into wallpaper so that the selected image can be set as a wallpaper (step S90).

However, the above-mentioned conventional method of setting the scan image as a wallpaper is inconvenient to the user, because the user has to do all of the operations to perform image scanning, enlargement reduction of the scanned image and setting of the wallpaper.

Furthermore, when the image data is scanned in accordance with the scan resolution and size of the original image, the scanned image data usually does not comply with the resolution of the display screen. Therefore, the scanned image needs be enlarged or reduced by use of professional image programs so as to suit the size of the display screen. Moreover, images usually deteriorate when enlarged.

Meanwhile, the user may check the resolution of the screen in advance and determine a suitable scan resolution in accordance with the checked resolution, so as to avoid inconvenient processes such as enlargement or reduction of the scanned image. However, because this process requires complicated computations, it is not convenient for an ordinary user.

### SUMMARY OF THE INVENTION

Accordingly, the present general inventive concept provides a system and a method thereof to set a scan image as wallpaper, which automatically adjusts a resolution of the scan image according to a screen size and resolution.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a system to set a scan image as a wallpaper, including a scanner having a scanning part to scan a document and to form image data corresponding to the scanned document, an interface to communicate with an external device, and a control part to control the scanning part and the interface to transfer the image data to the external device via the interface, and a host connected with the scanner, and having a driver program unit to drive the scanner, an application program unit to generate an image file by processing the image data transferred from the scanner, and a monitor to display the image file, wherein, when an automatic wallpaper setting is set, the host processes the image data formed by the scanner according to a scan command, and sets the image file as wallpaper on the monitor according to a screen resolution of the monitor.

The scan command can include a scan resolution according to which the scanner scans the document.

The scan resolution can be computed by use of the screen resolution of the monitor.

The host can provide an input screen to select an area of the document to scan, and the host can compute the scan resolution by using a size of the selected scan area.

The foregoing and/or other aspects and advantages of the present general inventive concept are achieved by providing a method of setting a scanned image as wallpaper in a host connected with a scanner that scans a document and forms image data corresponding to the scanned document. The method includes loading a driver program to drive the scanner, determining if an automatic wallpaper setting operation is selected by a user, and if the automatic wallpaper setting operation is selected, transferring a scan command to the scanner according to the automatic wallpaper setting operation, receiving the image data from the scanner and processing the received image data according to the scan command to generate an image file, and setting the generated image file as wallpaper on a monitor of the host according to a screen resolution of the monitor.

The scan command transferred from the host to the scanner may include a scan resolution according to which the scanner scans the document.

The method may further include checking the screen resolution of the monitor.

The checking of the screen resolution of the monitor may include checking a size of an area to scan which is selected through an input screen provided to select the scan area.

The method may further include computing the scan resolution based on the screen resolution of the monitor and a size of the scan area.

The method may further include computing the scan resolution based on the screen resolution of the monitor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating a conventional method of setting a scan image as a wallpaper;

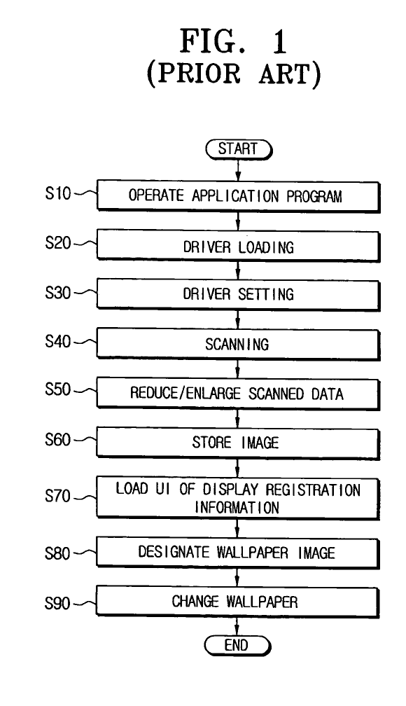

FIG. 2 is a view illustrating a scan image wallpaper setting system according to an embodiment of the present general inventive concept;

FIG. 3 is a block diagram illustrating the scan image wallpaper setting system of FIG. 2; and

FIG. 4 is a flowchart illustrating a method of setting a scan image as wallpaper according to an embodiment of the present general inventive concept.

### DETAILED DESCRIPTION OF THE PREFERRED EMBODIMENTS

In the following description, like drawing reference numerals are used for the like elements, even in different drawings. The matters defined in the description, such as a detailed construction and elements, are nothing but the ones provided to assist in a comprehensive understanding of the general inventive concept. Thus, it is apparent that the present general inventive concept can be carried out without those defined matters. Also, well-known functions or constructions are not described in detail since they would obscure the general inventive concept in unnecessary detail.

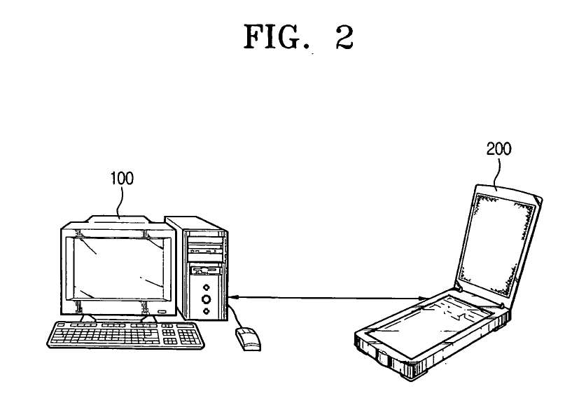

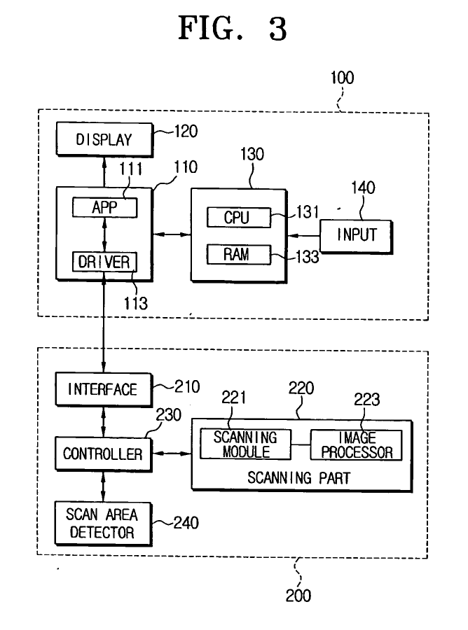

FIGS. 2 and 3 illustrate a scan image wallpaper setting system according to an embodiment of the present general inventive concept. Referring to FIGS. 2 and 3, the scan image wallpaper setting system includes a scanner 200 which scans an image and converts the scanned image into image data, and a host computer 100 which drives the scanner 200 and processes the image data transferred from the scanner 200.

The host computer 100 includes a hard disk drive 110 which has a driver program unit (driver) 113 to interface with the scanner 100 and an application program unit (APP) 111 to process the image data into an image file, a control part 130 which has a central processing unit (CPU) 131 and a RAM 133, an input 140, such as a keyboard and a mouse, and a display 120, such as a monitor, which displays image files processed in accordance with the APP 111.

The control part 130 can access the hard disk drive 110, and record image files in a memory (not shown), or select an image file of the memory (not shown) and load the selected image file to the RAM 133.

The APP 111 can include PhotoShop, Kodak imaging, or a variety of other image processing programs.

The driver 113 is installed in the hard disk drive 110 of the host computer 100 to interface the host computer 100 with the scanner 200. The APP 111 drives the scanner 200 via the driver 113 to scan an image, and receives scanned image data to process therein.

The driver 113 provides an input screen through the display 120 such that a user can select scanning options related to the scanning operation, such as a scan resolution, a scan area, and monochromatic or chromatic scanning options, for the scanned image data. The scan resolution may be set to 300 dpi (dots per inch), 600 dpi and 1200 dpi with respect to a document inserted in the scanner 200. The input screen additionally provides the user with a selection key through which the user can select a setting to automatically display the scanned image as wallpaper on the display 120 according to the present general inventive concept. Accordingly, the user may set the scanning options through the input screen by manipulating the input 140, or select the setting to automatically display the scanned image as wallpaper.

In the automatic display mode to display the scanned image as wallpaper, the driver 113 computes the scan resolution corresponding to a screen size of the display 120 according to a user-selected scan area and a resolution of the display 120, and transfers the computed scan resolution to the scanner 200 to control the scanning operation according to the computed scan resolution.

The scanner 200 includes an interface 210 to interface with the host computer 100, a scanning part 220 to scan an image of a document, a scan area detector 240 to detect the scan area of the scanning operation set by the user, and a controller 230 which controls the overall operations of the scanner 200.

The scanning part 220 includes a scanning module 221 to scan an image, and an image processor 223 to process the scanned image. The scanning module 221 can include a CCD image sensor (not shown), a lens and a light source (not shown), and is moved by a carriage return motor (not shown). The CCD image sensor includes a photoelectric converter which absorbs a reflective light from the object to generate an electric charge, an electric charge transfer part which transfers the electric charge generated from the photoelectric converter, and a signal detector which detects the transferred electric charge and converts the image information from the electric charge generated by the photoelectric converter into an electronic signal.

The image processor 223 processes the electronic signal from the scanning module 221 into image data, such as shading, gamma correction, conversion to dots-per-inch (dpi), edge emphasis, and error diffusion.

Meanwhile, the user can set the scan area through the driver 113. More specifically, the user may determine whether to scan the entire document or a part of the document. The scan area detector 240 detects the scan area of the document as set by the user, and the controller 230 controls the scanning part 220 to scan the detected scan area of the document according to the scanning options set by the driver 113 of the host computer 100, which are received through the interface 210.

The APP 111 and the driver 113 of the host computer 100 may be stored as software in a storage medium, such as the hard disk drive (HDD) 110 or a Flash ROM, but this should not be considered as limiting. For example, the APP 111 may be realized as separate LOGIC, such as ASIC, so as to enhance a processing speed of the host. Alternatively, the APP 111 and the driver 113 may also be realized as firmware in the Flash ROM, EEP-ROM and ROM, to be efficiently applicable to compact-size mobile phones and PDAs. In the embodiment as described above, the host may be a personal computer, a personal digital assistance (PDA), a laptop computer, a mobile phone, and a variety of processors and memory, such as a RAM, and can be realized as a device to process various image files.

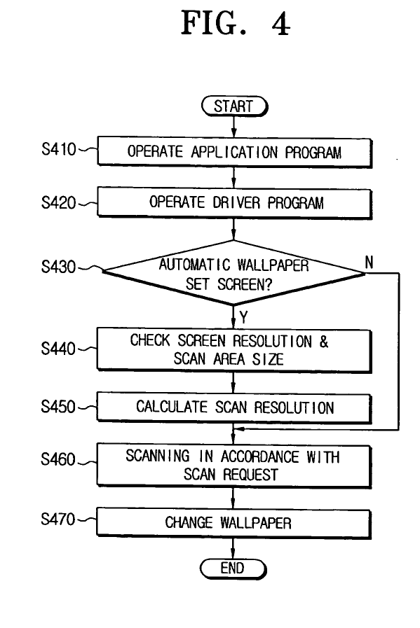

FIG. 4 illustrates a method of setting a scan image as wallpaper according to an embodiment of the present general inventive concept.

Referring to FIGS. 2-4, first, the user drives the APP 111 of the host computer 100 (operation S410), and operates the driver 113 to drive the scanner 200 to obtain scan image data (operation S420). The driver 113 determines whether an automatic wallpaper setting is set by the user (operation S430), and if so, checks the screen resolution of the display 120, such as 1152*864, 1024*768 and 800*600, and the size of the user-selected scan area of the document to be scanned (operation S440). The screen resolution of the display 120 and the user-selected scan area may be loaded from the memory (not shown) of the host 100 to the RAM 133 by the processor 131 of the control part 130, or may be provided through the input screen which is provided to select the scanning options.

Next, the driver 113 computes a scan resolution to be one of predetermined figures, such as 300 dpi and 600 dpi, based on the screen resolution and scan area size, such that the scan image data can be output as an image file having a suitable image quality for the screen size of the display 120 (operation S450).

The driver 113 then transfers a scan command including the computed scan resolution to the scanner 200, and the scanner 200 performs scanning according to the received command and the computed scan resolution (operation S460). When the scanned image data is transferred from the scanner 200, the data is processed into the image file in the APP 111, and stored in the memory (not shown). The driver 113 then sets the processed image file as wallpaper on the display 120 (step S470).

As described above, a wallpaper setting system according to the present general inventive concept computes a scan resolution based on a screen resolution of a monitor, performs scanning according to the computed resolution, and converts scanned image data to wallpaper. Because the wallpaper is automatically set according to the computed resolution, inconvenience of a user is reduced during the process of image scanning and wallpaper setting, and wallpaper of image quality and size suitable for the screen size and resolution can be obtained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A system to set a scan image as wallpaper, comprising:
a scanner including a scanning part to scan a document and to form image data corresponding to the scanned document, an interface to communicate with an external device, and a control part to control the scanning part and the interface to transfer the image data to the external device via the interface; and
a host connected with the scanner, and including a driver program unit to drive the scanner, an application program unit to generate an image file by processing the image data transferred from the scanner, and a monitor to display the generated image file, wherein when an automatic wallpaper setting is selected, the host processes the image data formed by the scanner according to a scan command, and automatically sets the image file as wallpaper on the monitor according to a screen resolution of the monitor.

2. The system of claim 1, wherein the scan command includes a scan resolution according to which the scanner scans the document.

3. The system of claim 2, wherein the scan resolution is computed based on a length and a width of the monitor.

4. The system of claim 3, wherein the host provides an input screen to select an area of the document to scan, and computes the scan resolution based on a size of the selected area.

5. A system to display an image as wallpaper, comprising:
a scanner to scan an image at a scan resolution; and
a host including a display, to adjust the scan resolution according to characteristics of the display and to automatically display a scanned image by the scanner at the adjusted scan resolution as wallpaper on the display.

6. The system of claim 5, wherein the characteristics of the display comprises at least one of a size and a resolution of the display.

7. The system of claim 5, wherein the host comprises:
a driver to determine the characteristics of the display, to adjust the scan resolution according to the determined characteristics of the display, and to drive the scanner to scan the image at the adjusted scan resolution.

8. The system of claim 5, wherein the host selects an area of the image to be scanned by the scanner, and adjusts the scan resolution according to the characteristics of the display and a size of the selected area.

9. A system to display an image as wallpaper, comprising:
a display unit to display a wallpaper image and having a predetermined resolution and size; and
a scanner to scan an image at a scan resolution determined according to at least one of the predetermined resolution and size of the display unit and to transmit the scanned image to the display unit to be automatically displayed at the determined scan resolution.

10. A host device usable with a scanning device, comprising:
a display to display wallpaper thereon; and
a driver to determine characteristics of the display, to drive the scanning device to input an image from the scanning device based on the determined characteristics, and to control the display to automatically display the input image as the wallpaper.

11. The host device of claim 10, wherein the driver controls the display to display an input menu to adjust scanning options of the scanning device and drives the scanning device according to the determined characteristic of the display and the adjusted scanning options of the scanning device.

12. A method of setting a scanned image as wallpaper in a host connected with a scanner that scans a document and forms image data corresponding to the scanned document, the method comprising:
loading a driver program in the host;
determining whether an automatic wallpaper setting operation is selected; and
if the automatic wallpaper setting operation is selected, transferring a scan command according to the automatic wallpaper setting operation from the driver program to the scanner to drive the scanner to form the image data, receiving the image data at the host from the scanner and processing the received image data according to the scan command to generate an image file, and setting the generated image file as wallpaper on a monitor of the host according to a screen resolution of the monitor.

13. The method of claim 12, wherein the scan command includes a scan resolution according to which the scanner scans the document.

14. The method of claim 12, wherein the transferring of the scan command comprises:
checking the screen resolution of the monitor;
generating the scan command based on the screen resolution of the monitor; and
transferring the generated scan command to the scanner.

15. The method of claim 14, wherein the checking of the screen resolution of the monitor comprises:
selecting an area of the document to scan through an input screen; and
checking a size of the selected area.

16. The method of claim 15, wherein the generating of the scan command comprises:
computing a scan resolution based the screen resolution of the monitor and the size of the selected area; and
generating the scan command including the computed scan resolution.

17. The method of claim 14, wherein the generating of the scan command comprises:
computing a scan resolution based on the screen resolution of the monitor; and
generating the scan command including the computed scan resolution.

18. The method of claim 12, wherein the setting of the generated image file as the wallpaper comprises:
automatically displaying the generated image file as the wallpaper on the monitor of the host when the automatic wallpaper setting operation is selected.

19. A method of setting a scanned image as wallpaper of a display, the method comprising:
determining a scan resolution based on at least one of a size and resolution of the display;
scanning an image according to the determined scan resolution; and
automatically setting the scanned image as wallpaper of the display.

20. The method of claim 19, wherein the determining of a scan resolution comprises;
determining the at least one of the size and resolution of the display; and
calculating the scan resolution based on the determined at least one of the size and resolution.

21. The method of claim 19, wherein the determining of the scan resolution comprises:
inputting an area of the image to scan; and
determining the scan resolution based on the at least one of the size and resolution of the display and a size of the input area.

22. The method of claim 19, wherein the automatically setting the scanned image as the wallpaper of the display comprises:
processing the scanned image into an image file of a predetermined format; and
automatically displaying the image file as the wallpaper.
